(19) United States
(12) Patent Application Publication
(10) Pub. No.: US 2026/0160506 A1
(43) Pub. Date: Jun. 11, 2026

(54) MULTI-DIRECTIONAL VIBRATING PROTRUSION COOLING SYSTEMS

(71) Applicant: Toyota Motor Engineering & Manufacturing North America, Inc., Plano, TX (US)

(72) Inventors: Taehwa Lee, Ann Arbor, MI (US); Xiaopeng Li, Ann Arbor, MI (US); Ziqi Yu, Ann Arbor, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/969,481

(22) Filed: Dec. 5, 2024

(51) Int. Cl. F28F 13/02

(52) U.S. Cl. CPC F28F 13/02

(57) ABSTRACT

Systems, methods, and other embodiments described herein relate to a cooling system that includes vibrating protrusions to disturb a dissipation-blocking thermal boundary layer. In one embodiment, a cooling system includes a base from which vibrating protrusions extend. The base exhibits 1) vibration at multiple frequencies in a first direction and 2) vibration at multiple frequencies in a second direction. The cooling system includes a first set of vibrating protrusions that vibrate in the first direction. Different vibrating protrusions in the first set have different resonance frequencies that align with the multiple frequencies in the first direction.

### TECHNICAL FIELD

The subject matter described herein relates, in general, to cooling systems and, more particularly, to cooling systems that include multi-directional and multi-resonance arrays of vibrating protrusions.

### BACKGROUND

Vehicles and other modes of transportation rely on various components to propel the vehicle forward. These components include moving parts, which, in many cases, move at high speeds. For example, engine components may translate or rotate thousands of times per minute. This movement and other operations of the vehicle components generate heat across the component surface and in the engine compartment in general. This generated heat, if unaddressed, may cause the vehicle to overheat, potentially rendering it temporarily unusable.

Overheating may also damage the component by warping or cracking the component material. Thus, overheating may also lead to long-term and potentially expensive repairs and/or replacement of vehicle components and may affect the long-term functionality of the vehicle in which the component is placed. Accordingly, some vehicles include cooling systems that draw heat away from radiating surfaces to prevent the likelihood of overheating and the negative results caused by overheating. However, for various reasons, including space constraints and thermodynamic inefficiencies, it may be difficult to implement a cooling system that can keep up with the heat-generating operations of a vehicle.

The effects of component-generated overheating are not limited to vehicle components. Thousands of other mechanical, electronic, and electrical devices generate heat during operation, which heat may reduce the operational capability and efficiency of the devices.

### SUMMARY

In one embodiment, example systems and methods relate to a manner of improving the heat dissipation of cooling systems.

In one embodiment, a cooling system for cooling a heated component is disclosed. The cooling system includes a base from which vibrating protrusions extend. The base exhibits 1) vibration at multiple frequencies in a first direction and 2) vibration at multiple frequencies in a second direction. The cooling system includes a first set of vibrating protrusions that vibrate in the first direction, different vibrating protrusions in the first set have different resonance frequencies that align with the multiple frequencies in the first direction.

In one embodiment, a cooling system for cooling a heated component includes a perforated base from which vibrating protrusions extend. The perforated base exhibits 1) vibration at multiple frequencies in a first direction and 2) vibration at multiple frequencies in a second direction. The cooling system includes a first set of vibrating protrusions that vibrate in the first direction, different vibrating protrusions in the first set have different resonance frequencies that align with the multiple frequencies in the first direction.

In one embodiment, a method for forming a cooling system with multi-directional and multi-resonance vibrating protrusion arrays is disclosed. In one embodiment, the method includes measuring a direction of 1) multiple vibration frequencies of a base in a first direction and 2) multiple vibration frequencies of the base in a second direction. The method also includes forming a first set of vibrating protrusions on the base to align with the first direction. Different vibrating protrusions of the first set have different resonances that align with different of multiple vibration frequencies in the first direction.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIGS. 1A and 1B are isometric views of a cooling system with multi-resonance vibrating posts according to an embodiment described herein.

FIG. 2 is an isometric view of a cooling system with multi-resonance vibrating beams according to an embodiment described herein.

FIGS. 3A and 3B are side views of a cooling system with multi-resonance vibrating beams according to an embodiment described herein.

FIG. 4 is a side view of a cooling system with multi-resonance vibrating protrusions according to an embodiment described herein.

FIGS. 5A and 5B are views of a cooling system with multi-resonance vibrating protrusions arranged in a tiled pattern according to an embodiment described herein.

FIGS. 6A and 6B are views of a cooling system with multi-resonance vibrating protrusions arranged in a circular arrangement according to an embodiment described herein.

FIG. 7 is a view of a cooling system disposed on a vehicle motor according to an embodiment described herein.

FIG. 8 is a side view of a cooling system with a perforated base parallel to and separated from a radiating body according to an embodiment described herein.

FIG. 9 is a side view of a cooling system with a perforated base extending from and perpendicular to a surface of a radiating body according to an embodiment described herein.

FIG. 10 illustrates a flowchart for one embodiment of a method that is associated with forming a cooling system with multi-directional and multi-resonance vibrating protrusions.

FIG. 11 is a graph depicting the vibration spectra of vibrating protrusions with different widths.

FIGS. 12A-12C depict the vibration response of a multi-resonance vibrating protrusion.

### DETAILED DESCRIPTION

Systems, methods, and other embodiments associated with improving the heat dissipation from radiating bodies, such as those that may be found on a vehicle, are described herein. As previously described, the engine of a vehicle or other motorized device, such as a motorcycle, scooter, etc., may include rapidly moving parts. The movement of these components may generate potentially catastrophic thermal profiles. If unaddressed, the generated heat may temporarily or permanently damage engine components and negatively affect the expected and safe operation of the vehicle.

Accordingly, heat sinks may be attached to heat-generating surfaces. In general, a heat sink is an object that absorbs or dissipates heat from another object via thermal contact. One specific example of a heat sink is a heat-dissipating protrusion that extends from the surface of a radiating body. For example, a motorcycle engine may include cooling fins that extend from the exterior surface of an engine component. In principle, heat-dissipating protrusions increase the surface area from which heat may be radiated away from the radiating body. As such, heat-dissipating protrusions and heat sinks generally remove heat generated as a by-product of component operation. The heat sinks prevent undesirable and potentially destructive temperatures in heat-generating components.

While heat-dissipating protrusions may prevent damage to heat-generating components, their efficiency may be limited by principles of thermodynamics. For example, a thermal boundary layer surrounds the heat-dissipating protrusions. A thermal boundary layer refers to the region of fluid (such as air) that is immediately adjacent to a heated surface. The thermal boundary layer has a large temperature gradient, which acts as an insulator, thus slowing down the rate of heat dissipation between the protrusions and the surrounding environment. Even with forced airflow, the thermal boundary layer may impede cooling. That is, the thermal boundary layer may counter and reduce the heat dissipation effect of any cooling system.

As vehicles become more efficient, include more mechanical and electromechanical systems, and exhibit increased performance to meet consumer demands, vehicle components may generate more heat, thus driving a desire for increasingly efficient cooling systems. This problem may be exacerbated in an engine compartment of a vehicle that is enclosed and where space is at a premium such that large complex heat dissipation systems are impractical.

Accordingly, to ensure the proper operation and longevity of the component to which it is affixed, the cooling system of the present specification describes a cooling system that disturbs the thermal boundary layer around heat-dissipating protrusions and, therefore, increases the efficacy of vehicle component cooling systems. That is, higher heat transfer may be attained by breaking/disturbing the aforementioned thermal boundary layer.

Specifically, the present specification describes a cooling system with heat-dissipating protrusions that vibrate. The vibration of the heat-dissipating protrusions disturbs the thermal boundary layer, thus reducing the layer's insulation effect and increasing the heat dissipation rate through the heat-dissipating protrusions. In other words, vibrating protrusions dissipate thermal energy more efficiently than static protrusions.

In an example, rather than being artificially vibrated via a powered vibration source, the heat-dissipating vibrating protrusions may be mounted directly to a vibration source, such as an engine component or an engine fan. That is, in addition to generating heat, some vehicle components vibrate during operation. The natural vibration of the component may drive the vibration of the fins of the cooling system attached to the component. Thus, the vibration of the component to which it is mounted induces boundary layer-disturbing vibrations in the heat-dissipating vibrating protrusions.

Still further, components that themselves do not vibrate may vibrate due to the vibration of attached components. For example, a battery cooling system may not exhibit inherent vibration but may vibrate due to its proximity and connection to a vibrating frame of the vehicle. Heat-dissipating vibrating protrusions may also be placed on these components, which do not inherently vibrate but vibrate due to adjacent and/or connected vibrating components and/or the overall vibration of the vehicle.

In either case, the boundary-disrupting effect of a heat-dissipating vibrating protrusion is maximized when the vibrating protrusion is driven at its resonance frequency. The resonance frequency for a particular heat-dissipating vibrating protrusion is defined by its physical dimensions (e.g., its length and width). Accordingly, in an example, the physical dimensions of the heat-dissipating vibrating protrusions of a cooling system of the present specification are selected based on the detected vibrations of the body to which the cooling system is attached. Specifically, the heat-dissipating vibrating protrusions have physical properties that result in a resonance frequency that aligns with the vibration frequencies of the vibrating heat-generating source to which it is mounted.

During use, vibrating heat-generating components may vibrate at different and/or multiple frequencies. These vibrations may have different directional components. In a single plane, the direction of vibration may refer to an angle of the back-and-forth movement relative to a reference line. For example, in a horizontal plane (e.g., parallel to a ground surface), the component may vibrate back and forth along a line that aligns with a reference line (e.g., a longitudinal axis of the component). In another example, the component may vibrate back and forth along a line at a non-zero angle to the longitudinal axis of the component. More practically, however, the component may vibrate in multiple directions (e.g., with a zero angle relative to the reference line and a non-zero angle relative to the reference line). In this example, the heat-dissipating vibrating protrusions may be arranged to harvest the multi-directional vibration.

In this way, the disclosed systems, methods, and other embodiments improve the efficiency and efficacy of cooling systems. That is, the present specification describes sets of heat-dissipating vibrating protrusions that 1) have different-sized heat-dissipating vibrating protrusions, the different sizes resulting in heat-dissipating vibrating protrusions with different resonances that align with the different vibrational frequencies of a component and 2) are positioned to align with a direction of the vibration. Accordingly, rather than targeting a particular and single vibrational frequency to drive the heat-dissipating vibrating protrusions, to the exclusion of other vibrational frequencies, the array of the presently described cooling system harvests multiple vibrational frequencies to drive multiple sizes of heat-dissipating vibrating protrusions to resonance. That is, the cooling system of the present specification accounts for the directionality of source vibration and the multi-frequency nature of naturally occurring vibrations to more efficiently harvest a greater portion of the vibration of a vibrating component to drive a greater number of heat-dissipating vibrating protrusions of the array to resonance. This increases the overall cooling performance of the cooling system as more system vibration is converted to heat-dissipating vibrating protrusion vibrations. As such, the present specification describes a system with tailored vibrating protrusion structure and orientation based on detected sources of vibration to increase the dissipation-promoting effect of heat-dissipating vibrating protrusions.

Note that while the present specification particularly describes the placement of the heat-dissipating vibrating protrusions on a vehicle component and other small-mobility devices (e.g., scooters, motorcycles, etc.), the present cooling system may be implemented on other components such as electrical components in computing devices.

As used herein, a “vehicle” is any form of transport that may be motorized or otherwise powered. In one or more implementations, the vehicle is an automobile. While arrangements will be described herein with respect to automobiles, it will be understood that embodiments are not limited to automobiles. In some implementations, the vehicle may be a robotic device or a form of transport that, for example, includes components that generate heat and/or vibrate and thus benefits from the functionality discussed herein associated with increasing the efficiency of component cooling systems.

As used herein, the term “align” means an exact match or slight variations therefrom. “Slight variations therefrom” can include within 15 degrees/percent/units or less, within 14 degrees/percent/units or less, within 13 degrees/percent/units or less, within 12 degrees/percent/units or less, within 11 degrees/percent/units or less, within 10 degrees/percent/units or less, within 9 degrees/percent/units or less, within 8 degrees/percent/units or less, within 7 degrees/percent/units or less, within 6 degrees/percent/units or less, within 5 degrees/percent/units or less, within 4 degrees/percent/units or less, within 3 degrees/percent/units or less, within 2 degrees/percent/units or less, or within 1 degree/percent/unit or less.

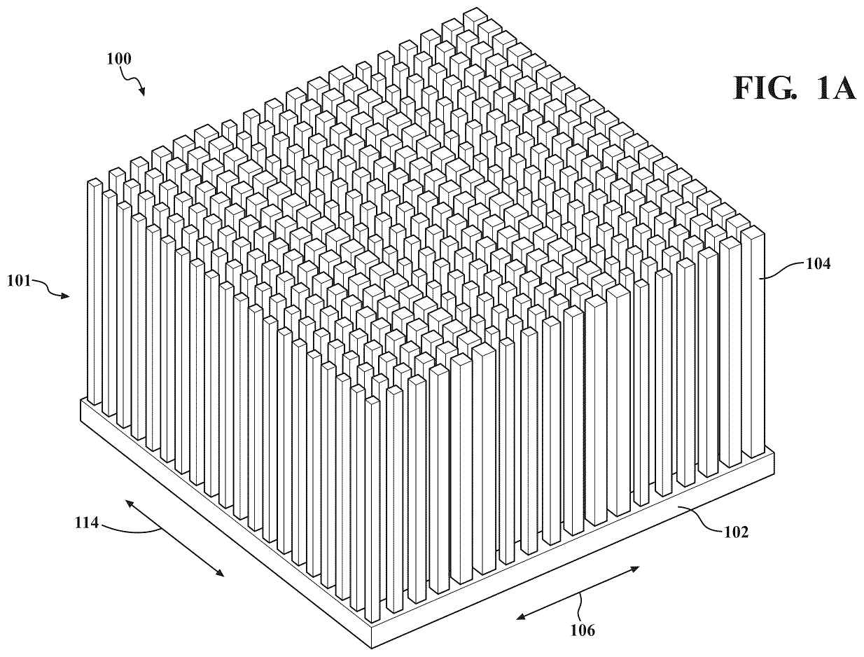

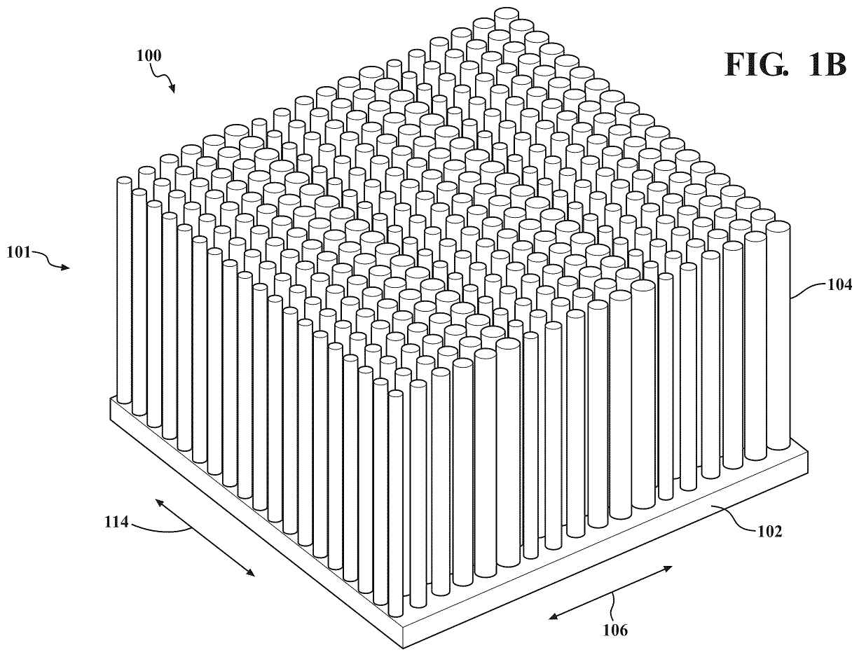

Turning now to the figures, FIGS. 1A and 1B are isometric views of a cooling system 100 with multi-resonance vibrating posts 104 according to an embodiment described herein. Specifically, FIG. 1A depicts square-shaped multi-resonance vibrating posts 104 and FIG. 1B depicts circular-shaped multi-resonance vibrating posts 104. It will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements.

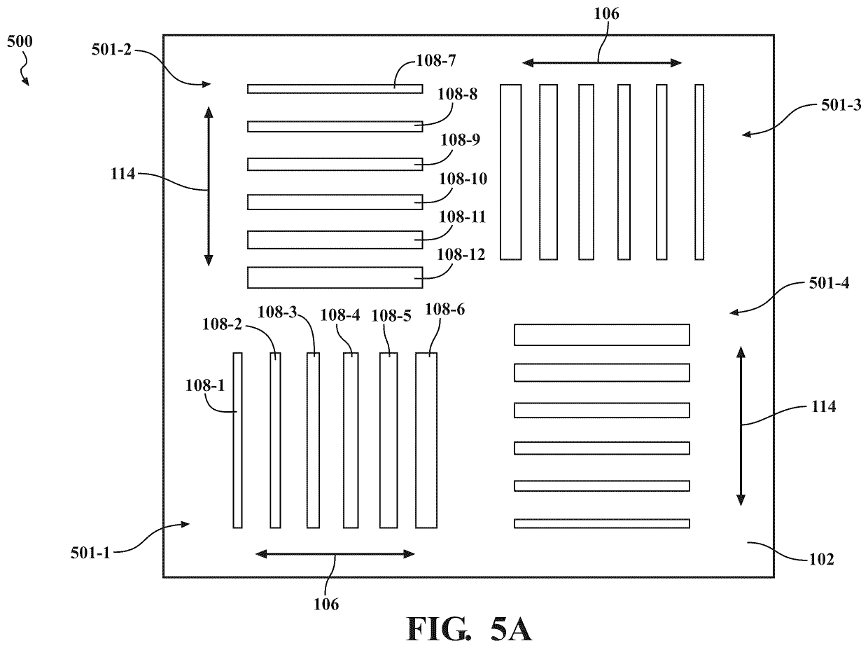

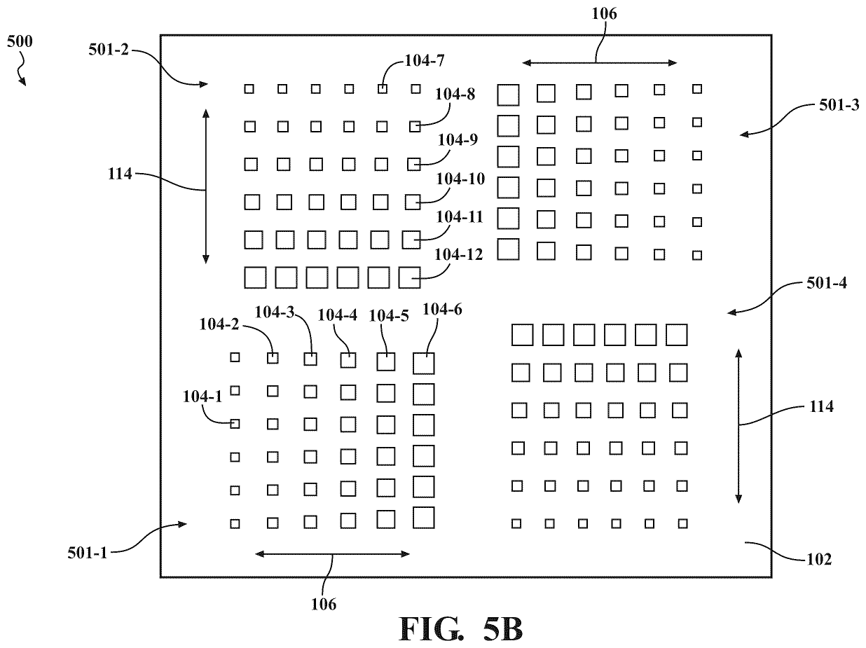

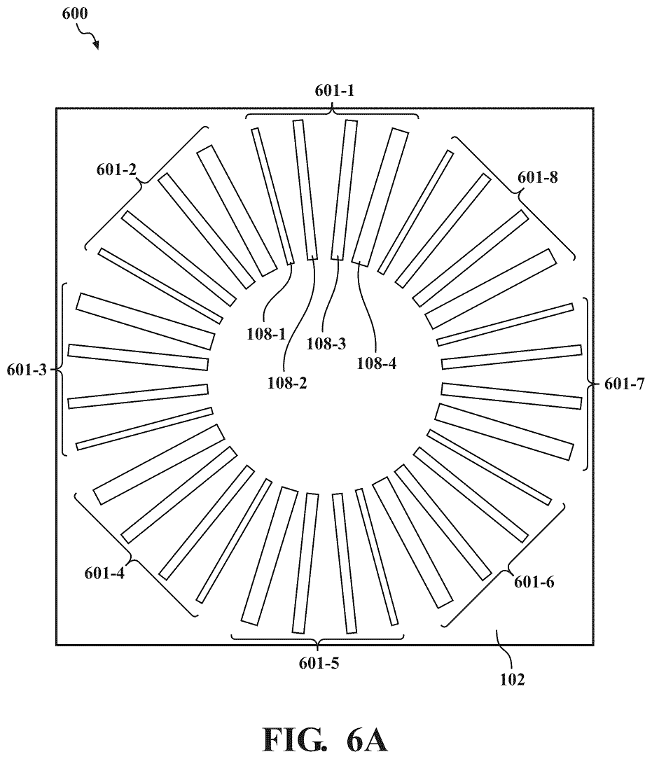

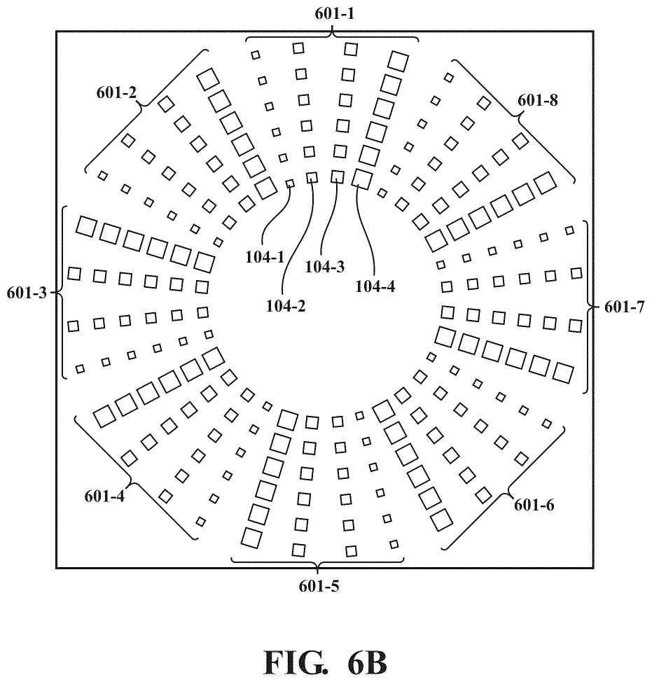

As described above, the cooling system 100 includes vibrating protrusions that extend from a base 102 that exhibits 1) vibration at multiple frequencies in a first direction and 2) vibration at multiple frequencies in a second direction. Accordingly, the cooling system 100 includes vibrating protrusions that harvest vibrational energy in both directions. This multi-directional harvesting may be accomplished via a single set of vibrating posts 104, as depicted in FIGS. 1A and 1B, or by multiple sets of vibrating posts/beams as depicted in FIGS. 5A-6B. That is, in the examples depicted in FIGS. 1A and 1B, vibrating posts 104 in the first set may harvest vibrational energy in the first direction 106 and may harvest vibrational energy in the second direction 114. Specifically, the square-shaped vibrating posts 104 and the circularly-shaped vibrating posts 104 may vibrate in the first direction 106 and a second direction 114. The circularly-shaped vibrating posts 104 depicted in FIG. 1B may harvest vibration in additional directions as well. FIGS. 1A-4 also depict a single set of vibrating protrusions, each divided into subsets.

By comparison, FIGS. 5A-6B depict examples of multiple sets of differently-oriented vibrating protrusions. In this example, different sets of vibrating protrusions may have different orientations on the component to harvest vibrations in different directions. As such, whether via a single set of protrusions or multiple sets of protrusions, the cooling system of the present specification enhances the cooling effect by arranging the vibrating protrusions to be aligned with the direction of component vibration. In either case, each set may include differently-sized vibrating protrusions with the different sizes selected to align with the different frequencies of vibration of the component to which it is attached.

In general, the vibrating protrusions extend perpendicularly from a base 102 surface. The base 102 may have various forms. In one example, the base 102 is the component surface that vibrates or is to be cooled. In this example, the vibrating protrusions may be integrated with the component (e.g., formed from a single mold that defines the component and vibrating protrusions) or directly attached to the component, for example, via welding, adhesion, or a fastener element (e.g., a bolt, screw, or rivet, etc.).

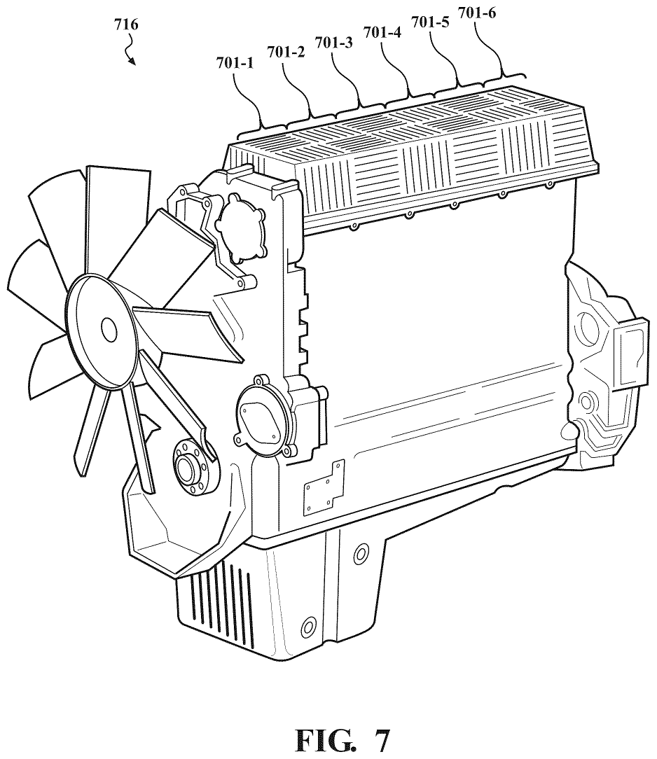

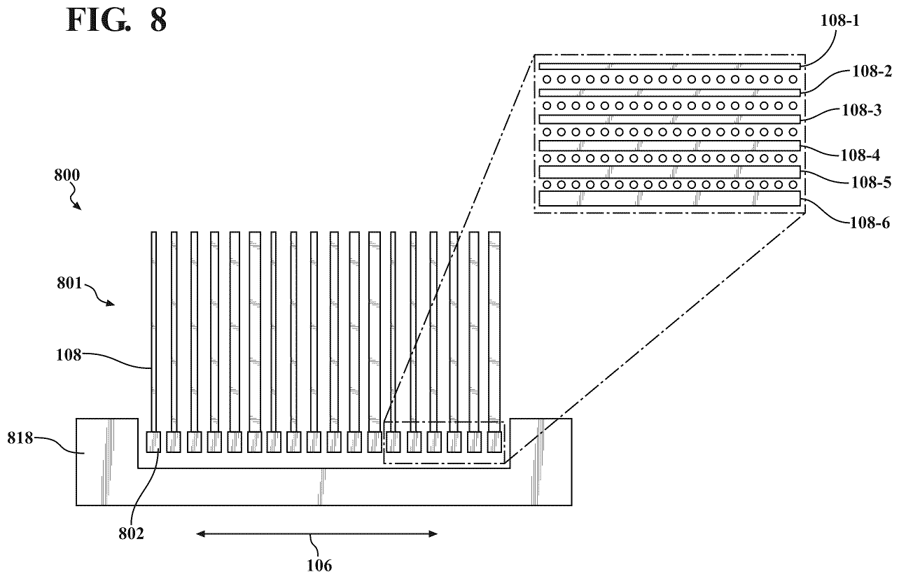

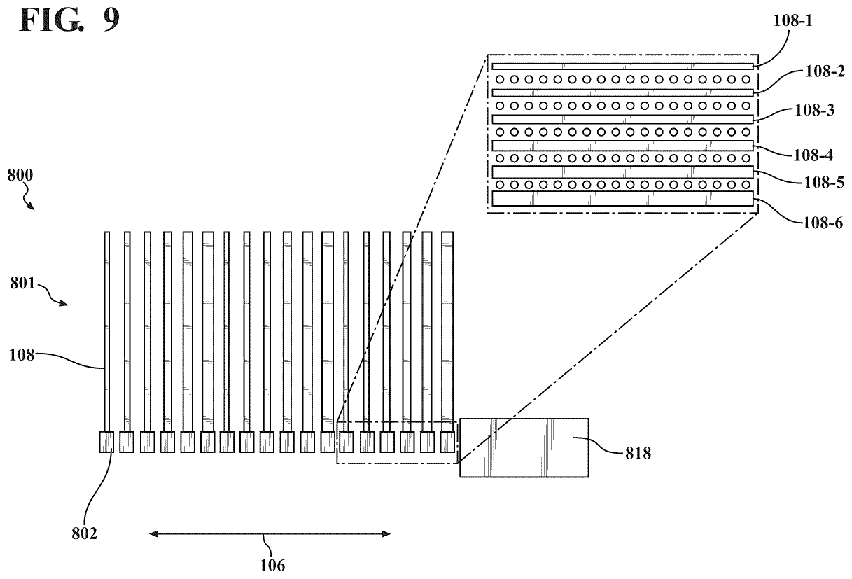

In another example, the base 102 may be an intermediate substrate attached to the component surface. For example, the base 102 may be a metallic structure that is attached via fasteners (e.g., screws, bolts, or rivets), welded, or otherwise joined to the component to be cooled. In this example, the vibrating protrusions may be integrated with the base 102 (e.g., formed from a single mold that defines the base 102 and the vibrating protrusions) or directly attached to the base 102, for example via welding, adhesion, or a fastener element (e.g., a bolt, screw, or rivet, etc.). In one example, as described below in connection with FIGS. 8 and 9, the base may be perforated to further enhance cooling via airflow between the vibrating protrusions. In either example, heat generated by the radiating component is transferred to the vibrating protrusions through the base 102. Note that while FIGS. 1A-6B, 8, and 9 depict the base 102 as being planar, in some examples, the base 102 may have a different shape, such as a curved shape to match a contoured component to which the cooling system 100 is attached. An example of such is depicted in FIG. 7, with the base 102 being an engine cover of a vehicle engine.

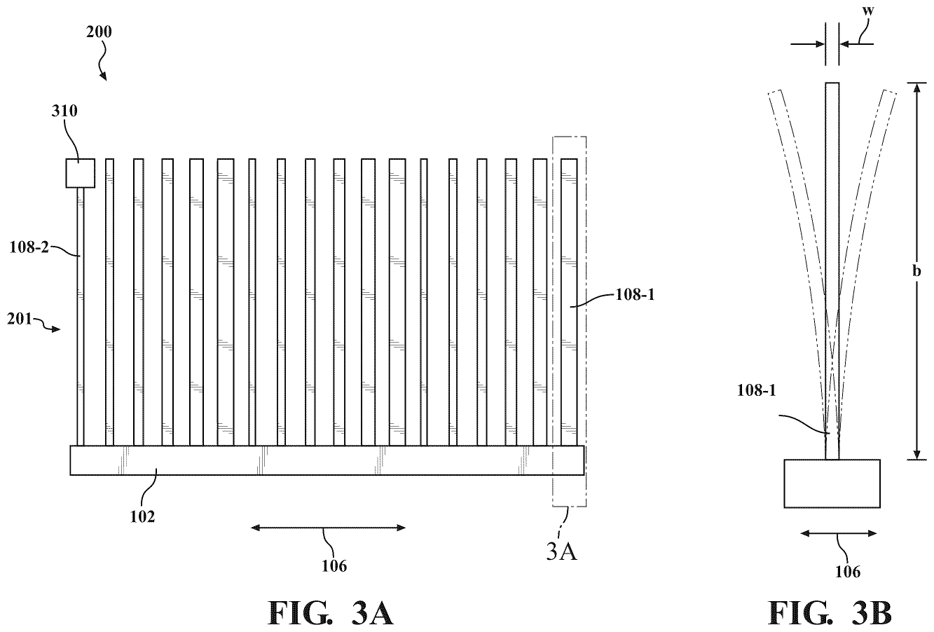

The vibrating protrusions may take various forms. For example, as depicted in FIGS. 1A and 1B, the vibrating protrusions may be vibrating posts 104 that extend from the base 102. For simplicity, FIGS. 1A and 1B depict a single vibrating post 104 with a reference number. As depicted in FIGS. 1A and 1B, the vibrating posts 104 of the cooling system 100 may be arranged in columns and rows. As described above, the individual vibrating posts 104 within a set 101 may have different dimensions, with the different dimensions selected to correspond to different of the multiple vibration frequencies that may manifest in a vibrating component to be cooled. Additional details regarding the specific sizing of vibrating protrusions to correspond to different vibrational frequencies are provided below in connection with FIGS. 3A and 3B.

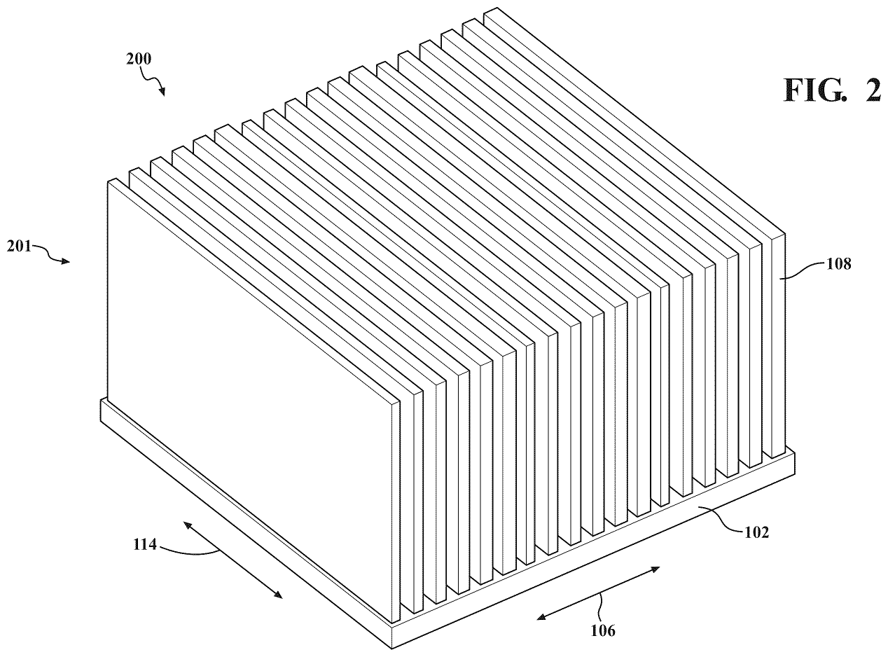

In the example depicted in FIG. 2, the vibrating protrusions are longitudinal beams 108 that extend from the base 102. For simplicity, FIG. 2 depicts a single vibrating beam 108 with a reference number. As depicted in FIG. 2, the vibrating beams 108 of the cooling system 200 may be arranged in rows. As described above, the vibrating beams 108 within a set 201 may have differing dimensions, with the different dimensions selected to correspond to different of the multiple vibration frequencies that may manifest in a vibrating component to be cooled. Additional details regarding the specific sizing of vibrating protrusions to correspond to different vibrational frequencies are provided below in connection with FIGS. 3A and 3B.

In the example depicted in FIG. 2, the base 102 may translate back and forth in the first direction 106. To enhance vibration and thus the cooling effect, set 201 of vibrating beams 108 may be arranged so that the direction of beam vibration aligns with the direction of component vibration.

Thus, as described above, the cooling system of the present specification efficiently harvests vibration at different frequencies and in different directions for cooling, which increases cooling performance. That is, other systems may have similarly sized protrusions and/or uni-directional protrusions. Similarly-sized protrusions resonate at the same frequency, even though a component may exhibit multiple vibration frequencies at different points in time or simultaneously. Thus, the different component vibrational profiles may be underutilized to drive heat-dissipating protrusions. In contrast, the vibrating protrusions of the present specification harvest a wider spectrum of vibration frequencies that may manifest in a vibrating component, thus increasing the vibration harvesting and cooling performance of the cooling system.

Similarly, uni-directional protrusions resonate in one direction, even though a component may exhibit multiple vibration directions at different points in time or simultaneously. For example, an engine component may exhibit circular vibration. Longitudinal beams that are oriented similarly may only vibrate in a single direction. Accordingly, the vibrational component in other directions is lost and not harvested. Thus, the different component vibrational profiles may be underutilized to drive heat-dissipating protrusions. In contrast, the vibrating protrusions of the present specification harvest a wider spectrum of vibration frequencies that may manifest in a vibrating component, thus increasing the vibration harvesting and cooling performance of the cooling system.

FIGS. 3A and 3B are side views of a cooling system 200 with multi-resonance vibrating beams 108 according to an embodiment described herein. Specifically, FIG. 3A is a side view of multiple vibrating beams 108, while FIG. 3B depicts the vibration of a single vibrating beam 108-1. Note that the indicator “—*” indicates a specific instance of an element, while the lack of such an indicator indicates a general instance of the element. Note also that the description relating to FIGS. 3A and 3B, which describe the determination of the size of a vibrating protrusion based on a detected vibration, applies to the cooling system 100, which incorporates vibrating posts 104.

As described above, during use, a structure (e.g., a vehicle component such as a motor, fan, or battery) may generate heat and may vibrate (either of its own accord or as the result of the vibration of another nearby and/or connected component). This vibration may be harvested to drive the vibrating protrusion, such as a vibrating beam 108 or a vibrating post 104, which vibration of the vibrating beam 108 or vibrating post 104 disturbs a thermal boundary layer surrounding the vibrating beam 108 or vibrating post 104 to increase the ability of the vibrating beam 108 or vibrating post 104 to draw heat away from the structure to the environment. Specifically, as depicted in FIG. 3B, as the base 102 vibrates in a first direction 106, the vibrating beams 108 also vibrate in the first direction 106. FIG. 3B depicts an example vibrating beam 108-1 vibrating in the first direction 106, however, all vibrating beams 108 in the set 201 that align with the first direction 106 may similarly vibrate in the first direction 106. Note that other vibrating protrusions that are not aligned with the first direction 106 may similarly vibrate, but to a lesser extent, and thus exhibit less of a boundary-layer disturbing effect. In other words, the cooling effect of a vibrating protrusion may be enhanced when its vibration direction aligns with the direction of component vibration.

Given that different vibrating protrusions have different resonances, on account of their different dimensions, different vibrational frequencies may drive different vibrating protrusions to resonance. Thus, otherwise wasted vibrational frequencies (i.e., those for which there is no corresponding vibrating protrusion with a corresponding resonance) are harvested for component cooling.

The vibrating protrusion geometry determines the resonance frequency of a vibrating protrusion. For example, the vibrating protrusion may have a rectangular cross-section, where a width, w, and height, b, define the resonance of the vibrating protrusion. In this example, the width, w, of the vibrating protrusion in a vibration direction (e.g., the first direction 106) and the height, b, of the vibrating protrusion in a direction perpendicular to the vibration direction (e.g., perpendicular to the first direction 106), is based on a vibration frequency of the base 102 in the respective direction (e.g., the first direction 106).

Specifically, the resonance frequency for a vibrating protrusion with a rectangular cross-section is given by Equation (1) below.

$${f}_{n} = \frac{{β}_{n}^{2}}{2 π {b}^{2}} \sqrt{\frac{EI}{ρ A}} \qquad Equation ( 1 )$$

In Equation (1), βₙ is the mode shape constant for the n-th mode, b is the height of the protrusion, E is the Young's Modulus of the material, I is the area moment of inertia of the cross-section, ρ is the density of the material, and A is the cross-sectional area. In Equation 1, n equals 1 for a first-order resonance frequency, and the higher-order frequencies may be calculated by setting n=2, 3, 4, etc.

The area moment of inertia, I, for a rectangular cross-sectional vibrating protrusion having a width, w, and a height, b, may be calculated using Equation (2) below.

$$I = \frac{1}{12} L {w}^{3} \qquad Equation ( 2 )$$

As described above, the vibrating protrusions may have other cross-sectional shapes, such as circular or square. A similar resonance determination may be calculated for a vibrating protrusion with any cross-sectional area. For example, the area moment of inertia, I, for a circular cross-sectional vibrating protrusion having a radius, r, may be calculated using Equation (3) below.

$$I = \frac{π}{4} {r}^{4} \qquad Equation ( 3 )$$

The resonance frequency of any cross-sectionally shaped vibrating protrusion may be similarly determined based on the area moment of inertia, I, associated with the vibrating protrusion's cross-sectional shape.

As described above, the dimensions of a vibrating protrusion may be selected based on the vibrational frequency of the component. For example, the vibration of an engine fan may be detected via an accelerometer. The dimensions of a rectangular vibrating protrusion may be determined 1) using Equations (1) and (2) and 2) setting the desired resonance frequency, fₙ, to a detected component vibrational frequency. This may be done for each detected vibrational frequency of the component, with different vibrating protrusions sized based on the different detected vibrational frequencies such that the cooling system enhances thermal boundary disruption by aligning the vibrating protrusion resonances to multiple detected vibrations.

In some examples, each vibrating protrusion, or some vibrating protrusions, such as a vibrating beam 108-2, may include a mass tip 310. This provides a further characteristic of the vibrating protrusion that may be adjusted to align the resonance frequency of the vibrating protrusion to the detected vibration frequency of the component. In an example, the resonance frequency of the vibrating protrusion with a mass tip 310 having mass, m, may be calculated using Equation (4) below.

$${f}_{n} = \frac{{β}_{n}^{2}}{2 π} \sqrt{\frac{EI}{ρ A {b}^{4} + m {b}^{3}}} \qquad Equation ( 4 )$$

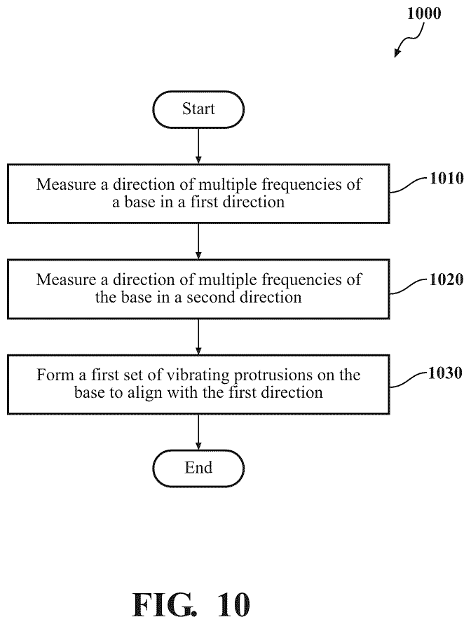

Accordingly, as described in additional detail below in regard to FIG. 10, the current cooling system may be tailored to a particular component by accounting for the specific directions and detected vibrational frequencies of a vibrating and radiating component.

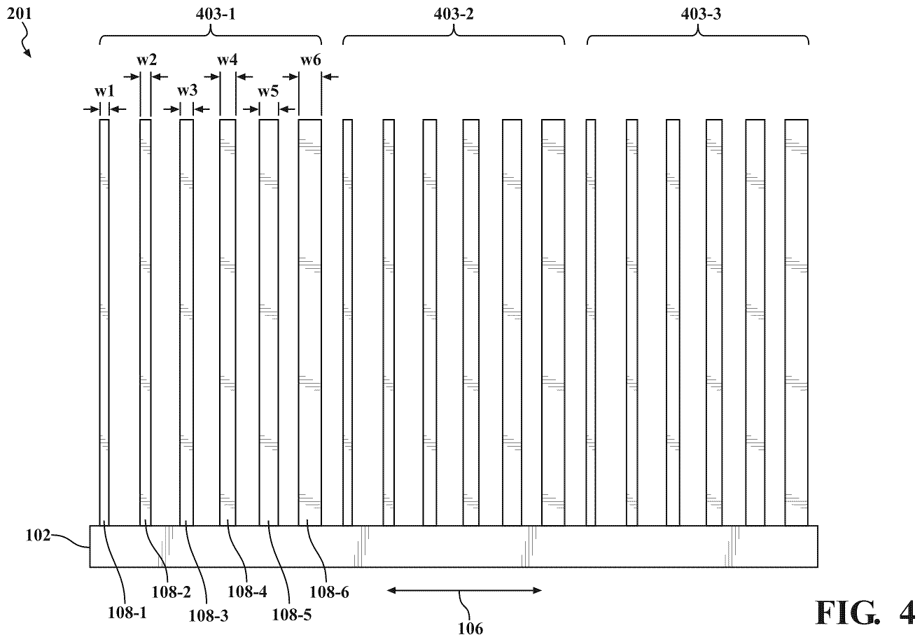

FIG. 4 is a side view of a cooling system with multi-resonance vibrating protrusions according to an embodiment described herein. As described above, each set 201 of vibrating protrusions (e.g., beams 108 or posts 104) may include differently-sized vibrating protrusions, each vibrating protrusion with a resonance that aligns with a different vibration frequency of the base 102 in a respective direction. In an example, a set 201 of vibrating protrusions may include multiple subsets 403-1, 403-2, and 403-3 of vibrating protrusions, whether vibrating beams 108 or vibrating posts 104, extending from the base 102 and align with the respective direction (e.g., the first direction 106).

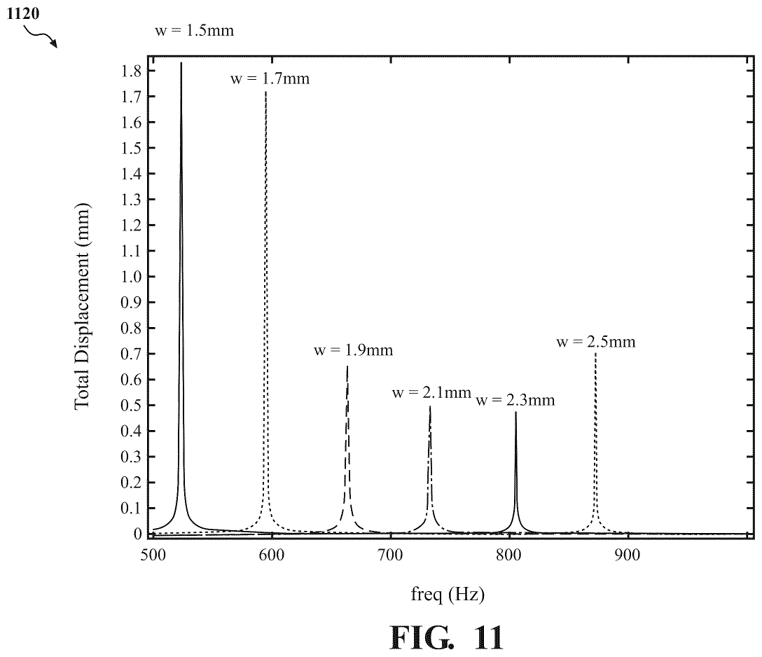

As described above, each vibrating protrusion has a resonance that aligns with a different vibration frequency of the base 102 in a respective direction (e.g., a first direction 106 or a second direction 114). For example, it may be that an accelerometer detects six vibrational frequencies (e.g., 524 hertz (Hz), 595 Hz, 664 Hz, 734 Hz, 806 Hz, and 873 Hz (as depicted in FIG. 11) of a component in a particular direction (e.g., the first direction 106). Accordingly, each set or subset 403-1, 403-2, and 403-3 may include six differently sized vibrating protrusions. As an example, a first vibrating beam 108-1 may have a width, w₁, corresponding to the first detected vibrational frequency (e.g., 524 Hz). Similarly, a second vibrating beam 108-2 may have a width, w₂, corresponding to the second detected vibrational frequency (e.g., 595 Hz), a third vibrating beam 108-3 may have a width, w₃, corresponding to the third detected vibrational frequency, (e.g., 664 Hz), a fourth vibrating beam 108-4 may have a width, w₄, corresponding to the fourth detected vibrational frequency, (e.g., 734 Hz), a fifth vibrating beam 108-5 may have a width, w₅, corresponding to the fifth detected vibrational frequency, (e.g., 806 Hz), and a sixth vibrating beam 108-6 may have a width, w₆, corresponding to the sixth detected vibrational frequency, (e.g., 873 Hz). Note that reference numbers and widths are provided just for the first subset 403-1. However, similar vibrating protrusions may be found in the second subset 403-2 and the third subset 403-3. FIG. 4 depicts the differently-sized vibrating protrusions in a single direction.

While FIG. 4 depicts multiple subsets per set, in some examples, such as that depicted in FIGS. 5A-6B, each set may include a single subset.

Moreover, as depicted in FIG. 4, in some examples the vibrating protrusions in a set 401 may be arranged in the respective direction (e.g., the first direction 106) based on increasing resonance and width.

FIGS. 5A and 5B are top views of cooling systems 500 with multi-resonance vibrating protrusions arranged in a tiled pattern according to an embodiment described herein. As described above, the cooling system 500 may include a base 102 from which vibrating protrusions extend. As described above, the vibrating protrusions may be vibrating beams 108, as depicted in FIG. 5A or vibrating posts 104, as depicted in FIG. 5B.

In either case, the vibrating protrusions are divided into sets 501, with different sets 501 of vibrating protrusions aligned with different detected vibrational directions of the radiating component. For example, as depicted in FIG. 5A some sets (e.g., a first set 501-1 and a third set 501-3) of vibrating beams 108 may vibrate in a first direction 106 while some sets (e.g., a second set 501-2 and a fourth set 501-4) of vibrating beams 108 vibrate in the second direction 114. In the example of vibrating posts, as depicted in FIG. 5B, each set (e.g., a first set 501-1, a second set 501-2, a third set 501-3, and the fourth set 501-4) may vibrate in a first direction 106 and a second direction 114. In the examples depicted in FIGS. 5A and 5B, the sets 501 are arranged into tiles with a first set in a first tile and a second set in a second tile.

As described above, different vibrating protrusions in the sets 501 have different resonance frequencies that align with the multiple vibration frequencies in a respective direction. For example, as depicted in FIG. 5A, the first set 501-1 includes vibrating beams 108-1, 108-2, 108-3, 108-4, 108-5, and 108-6 with different resonance frequencies/sizes that align with multiple frequencies in the first direction 106. Similarly, the second set 501-2 has vibrating beams 108-7, 108-8, 108-9, 108-10, 108-11, and 108-12 with different resonance frequencies/sizes that align with multiple frequencies in the second direction 114. For simplicity, reference numbers are provided for the vibrating beams 108 in the first set 501-1 and the second set 501-2. However, the third set 501-3 and the fourth set 501-4 may be similarly configured.

As depicted in FIG. 5B, the first set 501-1 includes vibrating posts 104-1, 104-2, 104-3, 104-4, 104-5, and 104-6 with different resonance frequencies/sizes aligning with multiple frequencies in the first direction 106 and the second direction 114. Similarly, the second set 501-2 has vibrating posts 104-7, 104-8, 104-9, 104-10, 104-11, and 104-12 with different resonance frequencies/sizes that align with multiple frequencies in the first direction 106 and the second direction 114. For simplicity, reference numbers are provided for the vibrating posts 104 in the first set 501-1 and the second set 501-2. However, the third set 501-3 and the fourth set 501-4 may be similarly configured. Moreover, for simplicity, a few instances of vibrating posts 104 from each row of vibrating posts 104 are identified with a reference number. In FIGS. 5A and 5B, the different resonance is indicated by the different widths of the vibrating beams 108 and vibrating posts 104 in each respective set.

In the examples depicted in FIGS. 5A and 5B, the second direction 114 is perpendicular to the first direction 106 and the first set 501-1 and the second set 501-2 are arranged in tiled patterns adjacent to one another.

FIGS. 6A and 6B are top views of a cooling system 600 with multi-resonance vibrating protrusions arranged in a circular arrangement according to an embodiment described herein. As described above, the cooling system 600 may include a base 102 from which vibrating protrusions extend. As described above, the vibrating protrusions may be vibrating beams 108, as depicted in FIG. 6A or vibrating posts 104, as depicted in FIG. 6B. In the example depicted in FIGS. 6A and 6B, the cooling system 600 may harvest the vibrations in more than two directions. Specifically, each set 601-1, 601-2, 601-3, 601-4, 601-5, 601-6, 601-7, and 601-8 harvests vibrations from a different direction. For example, it may be that within a given plane, a component vibrates circularly. As a specific example, a vehicle motor may vibrate in one direction (e.g., a forward and backward translational motion that aligns with a longitudinal axis of the vehicle) in a horizontal plane. In another example, the vehicle motor may exhibit circular vibration in the horizontal plane. Arranging the various sets 601 in a circular arrangement as depicted in FIGS. 6A and 6B may facilitate harvesting the vibrational frequencies of various directional components of the circular vibration. As another example, a component may vibrate in different directions at different points in time. Rather than confining vibration harvesting to one direction and reducing harvesting efficacy when vibration is in a different direction or not harvesting from differently oriented vibration, the present cooling systems capture vibrational energy from multiple directions (whether simultaneously or separately in time) to drive the vibrating protrusions.

As described above, different vibrating protrusions in the sets have different resonance frequencies that align with the multiple vibration frequencies in a respective direction. For example, as depicted in FIG. 6A, each set 601-1, 601-2, 601-3, 601-4, 601-5, 601-6, 601-7, and 601-8 includes vibrating beams 108-1, 108-2, 108-3, and 108-4 that have different resonance frequencies/sizes that align with multiple frequencies in the respective direction. For simplicity, reference numbers are provided for the vibrating beams 108 in the first set 601-1. However, the other sets are similarly configured.

As depicted in FIG. 6B, each set 601-1, 601-2, 601-3, 601-4, 601-5, 601-6, 601-7, and 601-8 includes vibrating posts 104-1, 104-2, 104-3, and 104-4 that have different resonance frequencies/sizes that align with multiple frequencies in the respective direction. For simplicity, reference numbers are provided for the vibrating posts 104 in the first set 601-1. However, the other sets are similarly configured. Moreover, for simplicity, a few instances of vibrating posts 104 from each row of vibrating posts 104 are identified with a reference number in FIG. 6B. In FIGS. 6A and 6B, the different resonance is indicated by the different widths of the vibrating beams 108 and vibrating posts 104 in each respective set.

Note that FIGS. 1-6B, 8, and 9 depict vibrating protrusion sets in a single plane with vibrating protrusions in different sets oriented differently. However, it may be the case that a component vibrates in three dimensions. Accordingly, the cooling system may be replicated on other surfaces of the component, with cooling systems in each plane to capture multiple frequencies at multiple orientations within the respective plane. As such, the cooling system of the present specification captures multi-angular and multi-planer vibration from a vibrating and heat-generating system.

Note also that while FIGS. 1-6B depict particular arrangements of the sets to capture different directional vibrations, different arrangements may be implemented in accordance with the principles described herein so long as multi-resonance arrays of vibrating protrusions capture vibrational frequencies in multiple directions.

FIG. 7 is a view of a cooling system disposed on a vehicle motor 716 according to an embodiment described herein. As described above, the cooling system may be mounted on any vibrating radiating component. As a particular example, a vehicle motor 716 is a vehicle component that vibrates due to the motion of internal components such as pistons. The movement of the pistons and the chemical reactions that provide the driving force also generate heat. Accordingly, the cooling system may be attached to or integrated with the engine cover to utilize the engine vibration to increase the efficacy of heat-dissipating vibrating protrusions. Specifically, as depicted in FIG. 7, multiple sets 701-1, 701-2, 701-3, 701-4, 701-5, and 701-6 of vibrating protrusions (whether vibrating beams 108 as depicted in FIG. 7 or vibrating posts 104) may be positioned on the engine body, at different orientations to harvest the multi-directional vibration to drive different sets 201 of vibrating protrusions to resonance to increase the cooling effect of the heat dissipating vibrating protrusions.

As described above, the vibrating protrusions may be affixed to the vehicle motor 716 in various ways. For example, the vibrating protrusions may be integrated with a surface (e.g., an engine cover) and formed as a single integrated component. In another example, the vibrating protrusions may be attached to a substrate that is separately attached to the vehicle component, for example, via welding or a fastener such as a screw, bolt, or rivet. In either case, the multi-directional and multi-resonance vibrating protrusion sets increase the efficiency of a cooling system by harvesting multiple vibrational frequencies in multiple directions to cool a radiating component, such as a vehicle motor 716. Again, note that while FIG. 7 depicts a particular component on which the cooling system is formed, the vibrating protrusions may be affixed to other components.

FIG. 8 is a side view of a cooling system 800 with a perforated base 802 parallel to and separated from a radiating body 818 according to an embodiment described herein. In some examples, to further increase the cooling effect, the cooling system 800 may include a perforated base 802, as depicted in FIG. 8. The vibrating protrusions remove heat from the radiating body 818 via conductive heat transfer. The apertures in the perforated base 802 may provide convective heat transfer between the vibrating protrusions (whether vibrating beams 108 as depicted in FIG. 8 or vibrating posts 104). This convective airflow may draw the heat away from the vibrating protrusions to the surrounding environment. The convective airflow increases the cooling effect of the cooling system by introducing a second heat transfer modality.

Note that FIG. 8 depicts a single set 801. However, as described above, the perforated base 802 may include multiple sets of vibrating protrusions.

To facilitate the convection, the perforated base 802 may be exposed on both sides (e.g., the side from which the vibrating protrusions extend and the opposing side). That is, a surface of the perforated base 802 opposite the vibrating protrusions may be exposed to allow air to travel through the perforated base 802. This may be accomplished in a variety of ways. In the example depicted in FIG. 8, the perforated base 802 may be parallel to and spaced apart from the surface of the radiating body 818. Specifically, both ends of the perforated base 802 may be affixed (i.e., welded or fastened) to the radiating body 818. In the example depicted in FIG. 9, the perforated base 802 is perpendicular to and extends from the surface of the radiating body 818. Put another way, in the example depicted in FIG. 9, the cooling system 900 is a cantilevered beam extending from the surface of the radiating body 818.

In either example, as the radiating body 818 vibrates in a direction (e.g., a first direction 106), the vibrating protrusions (in this example, vibrating beams 108) vibrate in the same direction to break down the thermal boundary layer that forms around the vibrating protrusions. Thus, the vibrating protrusions can draw heat away from the perforated base 802, which perforated base draws heat from the radiating body 818.

Note that while FIGS. 8 and 9 depict a perforated base 802 with particular perforation characteristics (i.e., spacing, longitudinal and lateral positioning, and dimensions) the perforated base 802 may have other characteristics to facilitate a desired airflow through the perforated base 802, which characteristics may be determined empirically through experimentation or otherwise.

FIG. 10 illustrates a flowchart for one embodiment of a method 1000 that is associated with forming a cooling system with multi-directional and multi-resonance vibrating protrusions.

As described above, a radiating body 818 may vibrate, whether of its own accord or responsive to the vibrations of a nearby and/or connected component. Specifically, within a single or multiple planes, the radiating body 818 may vibrate in multiple directions (i.e., at different orientations relative to a reference line within the plane) and may vibrate with different frequencies, either at the same time or at different points in time. To maximize the cooling effect of a cooling system, the vibrating protrusions of the present cooling system align with the directional vibrations of the radiating body 818 and have different resonances that align with the vibrational frequencies of the radiating body 818.

Accordingly, at 1010 and 1020, the method 1000 includes measuring a direction of multiple vibrational frequencies of a base 102 in at least a first direction 106 and measuring a direction of multiple vibrational frequencies of the base 102 in at least a second direction 114. Specifically, one or multiple accelerometers may be placed on the radiating body 818. In general, an accelerometer is a device that measures the vibration of a structure. The accelerometer may detect the intensity or frequency of vibrations and the direction of the multiple vibrations. As described above, the intensity/frequency of vibrations of the radiating body 818 and the direction of vibration may define the structure of the vibrating protrusions and the placement of the vibrating protrusions on the radiating body 818.

Accordingly, at 1030, the method 1000 includes forming a first set of vibrating protrusions on the base 102 to align with the first direction 106 and forming vibrating protrusions to have different resonances that align with different of the multiple vibrational frequencies in the first direction 106. Concerning the formation of the vibrating protrusions to have resonances that align with the detected vibrational frequencies of the radiating body/base 102, as described above, there is a relationship between resonance and protrusion dimensions. Accordingly, from Equation (1) and a respective area moment of inertia equation for a given cross-sectional shape, it may be determined what dimensions of a vibrating protrusion would result in a resonance frequency that aligns with the measured vibrational frequencies of the radiating body 818. FIG. 11 below depicts specific relationships between resonance frequency and rectangular vibrating protrusion widths. Accordingly, in this example, dimensions for the vibrating protrusions in the first set may be selected to result in resonances that align with the detected vibrational frequencies of the radiating body 818. Specifically, multiple vibrational frequencies may be detected, and vibrating protrusion dimensions associated with each vibrational frequency may be determined.

The vibrating protrusions defined by these determined dimensions may then be formed in various ways, including molding, machining, etching, laser cutting, or the like. In these examples, the vibrating protrusions may be attached to the base 102 (which base may be an intermediate substrate or the radiating body 818 itself) in many ways, including welding and/or fastening. In one particular example, the vibrating protrusions may be integrated with the radiating body 818. In this example, the vibrating protrusions, with their determined characteristics, may be cast in a mold along with the radiating body.

Regarding the directionality of the vibrating protrusions, the first set of vibrating protrusions may be placed on the radiating body 818 (either directly or through an intermediary substrate) at an angle to align with the direction of vibration. For example, given a measured first direction of vibration of 30 degrees (i.e., the component vibrates back and forth along a line that is 30 degrees from a reference line such as a longitudinal axis of the radiating body 818), the first set of vibrating protrusions may be formed (e.g., welded, molded into, or otherwise fastened) to the radiating body 818 such that the vibrating direction of the vibrating protrusions is 30 degrees off center from the reference line. Again, as described above, these vibrating protrusions may be attached to the base 102 (which base may be an intermediate substrate or the radiating body 818 itself) in many ways, including welding and/or fastening. In one particular example, the vibrating protrusions may be integrated with the radiating body 818.

Similarly, in the case where the vibrating protrusions of the first set do not harvest vibrational energy from other directions, the method may include forming a second set of vibrating protrusions on the base 102 to align with the second direction and forming vibrating protrusions to have different resonances that align with different of the multiple vibrational frequencies in the second direction 114. Concerning the formation of the vibrating protrusions to have resonances that align with the detected vibrational frequencies of the radiating body/base 102, as described above, there is a relationship between resonance and protrusion dimensions. Accordingly, from Equation (1) and a respective area moment of inertia equation for a given cross-sectional shape, it may be determined what dimensions of a vibrating protrusion would result in a resonance frequency that aligns with the measured vibrational frequencies of the radiating body 818. Accordingly, in this example, dimensions for the vibrating protrusions in the second set may be selected to result in resonances that align with the detected vibrational frequencies of the radiating body 818. Specifically, multiple vibrational frequencies may be detected, and protrusion dimensions associated with each vibrational frequency may be determined.

The vibrating protrusions defined by these determined dimensions may then be formed in various ways, including molding, machining, etching, laser cutting, and the like. In these examples, the vibrating protrusions may be attached to the base 102 (which base may be an intermediate substrate or the radiating body 818 itself) in many ways, including welding and/or fastening. In one particular example, the vibrating protrusions may be integrated with the radiating body 818. In this example, the vibrating protrusions, with their determined characteristics, may be cast in a mold along with the radiating body.

Regarding the directionality of the vibrating protrusions, the second set of vibrating protrusions may be placed on the radiating body 818 (either directly or through an intermediary base 102) at an angle to align with the second direction of vibration. For example, given a measured second direction of vibration of −60 degrees (i.e., the component vibrates back and forth along a line that is −60 degrees from a reference line such as a longitudinal axis of the radiating body 818), the first set of vibrating protrusions may be formed (e.g., welded, molded into, or otherwise fastened) to the radiating body 818 such that the vibrating direction of the vibrating protrusions is −60 degrees off center from the reference line. Again, as described above, these vibrating protrusions may be attached to the base 102 (which base may be an intermediate substrate or the radiating body 818 itself) in many ways, including welding and/or fastening. In one particular example, the vibrating protrusions may be integrated with the radiating body 818.

In the example where the base 102 is a perforated base 802, the sets of vibrating protrusions may be formed on the perforated base 802 as described above via fastening, welding, or integration with the perforated base 802 itself.

FIG. 11 is a graph 1120 depicting the vibration spectra of vibrating protrusions with different widths. Specifically, the graph 1120 depicts the resonance of multiple 50-millimeter (mm) tall protrusions with different widths. As described above, there is a relationship between resonance frequency and dimensions of the vibrating protrusion. As depicted in FIG. 11, the resonance frequency of a vibrating protrusion increases with the width of the vibrating protrusion.

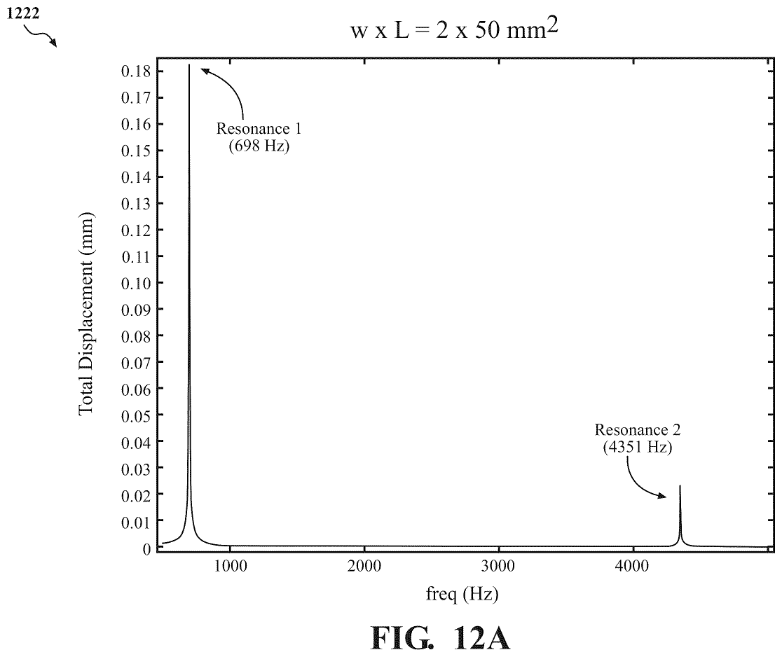

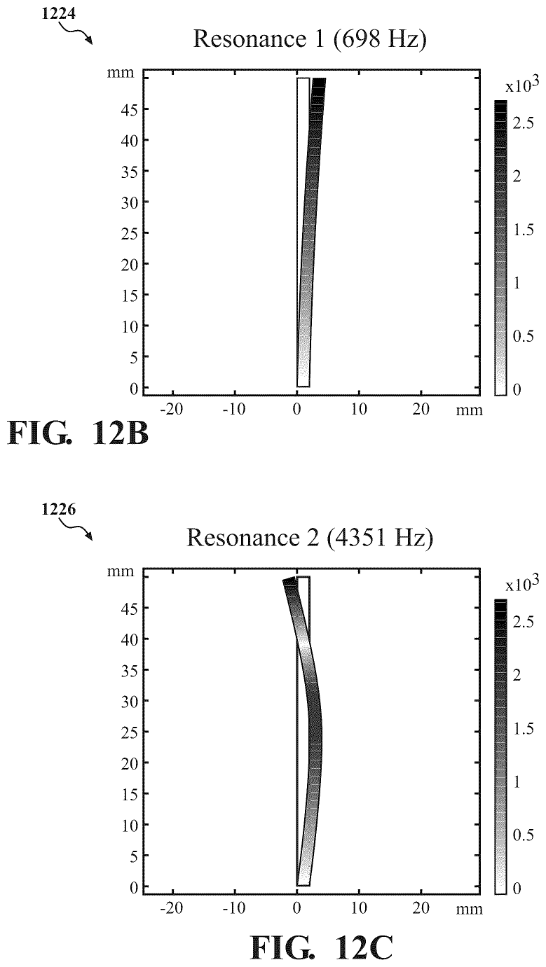

FIGS. 12A-12C depict the vibration response of a multi-resonance vibrating protrusion. In an example, a vibrating protrusion may exhibit resonance at multiple frequencies. The multiple resonance frequencies may align with multiple vibration frequencies of the base 102 in a respective direction. As such, a single vibrating protrusion having a particular size may harvest multiple vibrational frequencies to disrupt the thermal boundary layer surrounding the vibrating protrusion. FIG. 12A is a graph 1222 that shows the vibration response of a multi-resonance vibrating protrusion. Each resonance peak may exhibit a different vibration mode. FIG. 12B depicts a graph 1224 illustrating a first vibration mode of the multi-resonance vibrating protrusion, and FIG. 12C depicts a graph 1226 illustrating a second vibration mode of the multi-resonance vibrating protrusion.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1A-12C, but the embodiments are not limited to the illustrated structure or application.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A cooling system, comprising:
a base, from which vibrating protrusions extend, that exhibits:
vibration at multiple frequencies in a first direction; and
vibration at multiple frequencies in a second direction; and
a first set of vibrating protrusions that vibrate in the first direction, different vibrating protrusions in the first set have different resonance frequencies that align with the multiple frequencies in the first direction.

2. The cooling system of claim 1, wherein the first set of vibrating protrusions vibrate in the second direction, different vibrating protrusions in the first set have different resonance frequencies that align with the multiple frequencies in the second direction.

3. The cooling system of claim 1, wherein the vibrating protrusions are circularly arranged on the base.

4. The cooling system of claim 1, further comprising a second set of vibrating protrusions that vibrate in the second direction, different vibrating protrusions in the second set have different resonance frequencies that align with the multiple frequencies in the second direction.

5. The cooling system of claim 4, wherein:
the first set of vibrating protrusions are arranged on a first tile; and
the second set of vibrating protrusions is arranged on a second tile adjacent to the first tile.

6. The cooling system of claim 1, wherein the first set of vibrating protrusions comprises multiple subsets of vibrating protrusions extending from the base and that align with the first direction.

7. The cooling system of claim 1, wherein:
the base is a perforated base; and
the perforated base is parallel to and spaced apart from a surface of a radiating body.

8. The cooling system of claim 1, wherein:
the base is a perforated base; and
the perforated base is perpendicular to and extends from a surface of a radiating body.

9. The cooling system of claim 1, wherein a vibrating protrusion exhibits resonance at multiple frequencies to align with multiple vibration frequencies of the base in the first direction.

10. A cooling system, comprising:
a perforated base, from which vibrating protrusions extend, that exhibits:
vibration at multiple frequencies in a first direction; and
vibration at multiple frequencies in a second direction; and
a first set of vibrating protrusions that vibrate in the first direction, different vibrating protrusions in the first set have different resonance frequencies that align with the multiple frequencies in the first direction.

11. The cooling system of claim 10, wherein the first set of vibrating protrusions vibrate in the second direction, different vibrating protrusions in the first set have different resonance frequencies that align with the multiple frequencies in the second direction.

12. The cooling system of claim 10, wherein the vibrating protrusions are circularly arranged on the perforated base.

13. The cooling system of claim 10, further comprising a second set of vibrating protrusions that vibrate in the second direction, different vibrating protrusions in the second set have different resonance frequencies that align with the multiple frequencies in the second direction.

14. The cooling system of claim 13, wherein:
the first set of vibrating protrusions are arranged in a first tile; and
the second set of vibrating protrusions is arranged on a second tile adjacent to the first tile.

15. The cooling system of claim 11, wherein the perforated base is:
parallel to and spaced apart from a surface of a radiating body; or
perpendicular to and extends from a surface of the radiating body.

16. A method, comprising:
measuring a direction of:
multiple vibration frequencies of a base in a first direction;
multiple vibration frequencies of the base in a second direction; and
forming a first set of vibrating protrusions on the base to align with the first direction, different vibrating protrusions of the first set to have different resonances that align with different of multiple vibration frequencies in the first direction.

17. The method of claim 16, wherein forming the vibrating protrusions on the base comprises forming the vibrating protrusions on the base in a circular arrangement.

18. The method of claim 16, further comprising forming a second set of vibrating protrusions on the base to align with the second direction, different vibrating protrusions of the second set to have different resonances that align with different of multiple vibration frequencies in the second direction.

19. The method of claim 18, wherein:
forming the first set of vibrating protrusions on the base comprises forming the first set of vibrating protrusions in a first tile; and
forming the second set of vibrating protrusions on the base comprises forming the second set of vibrating protrusions on a second tile adjacent to the first tile.

20. The method of claim 18, wherein:
forming the first set of vibrating protrusions on the base comprises forming the first set of vibrating protrusions on a perforated base; and
forming the second set of vibrating protrusions on the base comprises forming the second set of vibrating protrusions on the perforated base.
